(19) United States
(12) Patent Application Publication
(10) Pub. No.: US 2026/0017487 A1
(43) Pub. Date: Jan. 15, 2026

(54) GENERATING LONG-TERM MEMORY FOR ORCHESTRATION AGENT SESSIONS

(71) Applicant: Amazon Technologies, Inc., Seattle, WA (US)

(72) Inventors: Shivank Goel, Seatte, WA (US); Subhojit Das, Bellevue, WA (US); John Baker, Bellevue, WA (US); Navneet Sabbineni, Bellevue, WA (US); Salvatore Romeo, Alexandria, WA (US); Yi Zhang, Sammamish, WA (US); Anurag Pratik, New York, NY (US); Jinglun Cai, Seattle, WA (US); Daniele Bonadiman, Sunnyvale, CA (US); Tamer A N Alkhouli, San Jose, CA (US); Monica Lakshmi Sunkara, San Francisco, CA (US); Yassine Benajiba, Briarclieff Manor, NY (US); Tejas Dastane, Seattle, WA (US); Santosh Kumar Ameti, Bellevue, WA (US); Aikaterini Margatina, New York, NY (US); Shubham Jayant Divekar, Seattle, WA (US)

(73) Assignee: Amazon Technologies, Inc., Seattle, WA (US)

(21) Appl. No.: 18/901,452

(22) Filed: Sep. 30, 2024

Related U.S. Application Data
(60) Provisional application No. 63/669,154, filed on Jul. 9, 2024.

(51) Int. Cl. G06N 3/0442; G06N 3/0475; H04L 51/02

(52) U.S. Cl. CPC G06N 3/0442; G06N 3/0475; H04L 51/02

(57) ABSTRACT

Long-term memory data objects may be generated for orchestrations agents. When a session completes or ends, a long-term memory data object may be generated according to a specified long-term memory type based on turn inputs during the session. When a new session is started, the long-term memory data object may be used as part of inputs to a generative machine learning model to perform or respond to turn inputs of the new session.

### RELATED APPLICATIONS

This application claims benefit of priority to U.S. Provisional Application Ser. No. 63/669,154, entitled “GENERATING LONG-TERM MEMORY FOR ORCHESTRATION AGENT SESSIONS,” filed Jul. 9, 2024, and which is incorporated herein by reference in its entirety.

### BACKGROUND

Neural network models, such as transformer-based models, have become increasingly more capable in solving complex problems in various domains in recent years. Some large models may have billions of parameters. Training and executing the models, as well as applications built using the models, can require substantial computing resources.

### BRIEF DESCRIPTION OF THE DRAWINGS

FIG. 1 illustrates a logical block diagram illustrating generating long-term memory for orchestration agent sessions, according to some embodiments.

FIG. 2 is a logical block diagram illustrating a provider network offering a natural language generative service that implements generating long-term memory for orchestration agent sessions, according to some embodiments.

FIG. 3 is a logical block diagram illustrating interactions to create an orchestration agent and specify a long-term memory type at the natural language generative service, according to some embodiments.

FIG. 4 is a logical block diagram illustrating interactions to capture session short term memory, according to some embodiments.

FIG. 5 is a logical block diagram illustrating interactions with long-term memory management, according to some embodiments.

FIG. 6A is a logical illustration of different types of memory for applications using orchestration agents, according to some embodiments.

FIG. 6B is illustrates examples between shared and user-specific long-term memories, according to some embodiments.

FIG. 7 is a high-level flowchart illustrating various methods and techniques to implement generating long-term memory for orchestration agent sessions, according to some embodiments.

FIG. 8 is a high-level flowchart illustrating various methods and techniques to generating specified types of long-term memory for orchestration agent sessions, according to some embodiments.

FIG. 9 illustrates an example system configured to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques of generating long-term memory for orchestration agent sessions are described herein. Orchestration agents may enable generative (Artificial Intelligence) AI applications to execute multistep tasks across systems and data sources. With Orchestration agents developers can build conversational assistants and/or automate workflows to improve productivity for a wide variety of applications. As developers scale their Generative AI applications running with orchestration agents, they want to build agents that retain context and understand user preferences. For instance, if a user was in the process of booking a flight and had to step out for an urgent meeting. The next time the user comes back to the assistant, it would remember where the conversation context and allow the user to pickup the flight booking from where they left off.

In addition to supporting short term memory, (e.g., an orchestration agent could retain context within the session, but not across sessions), in various embodiments, long term memory may be implemented, allowing, for example, orchestration agents to retain context across sessions, enabling developers to build smarter assistants that can respond to queries and orchestrate workflows more accurately. In various embodiments, long term memory provides developers with controls to enable and disable the capability, configure the topics of interest that they want to retain, the time frame for retention, and also the ability to make the agent forget its memory. In some embodiments, the context is securely retained with a session identifier (e.g., if you have multiple users using the chat assistant, each gets their exclusive memory space).

Generative machine learning models refer to machine learning techniques that model different types of data in order to perform various data generative tasks given a prompt. For example, natural language generative machine learning models, such as large language models (LLMs), are one type of generative machine learning model that refer to machine learning techniques applied to model language, which may include natural language (e.g., human speech) and machine-readable language (e.g., programming languages, scripts, code representations, etc.). For generative machine learning models that model language, the generative machine learning models may take language prompts and generate corresponding programming language predictions (which may be referred to as code predictions or code suggestions)

Generative machine learning models that generate language to perform various natural language processing tasks, are a form of machine learning that provides language processing capabilities with wide applicability to a number of different systems, services, or applications. More generally, machine learning refers to a discipline by which computer systems can be trained to recognize patterns through repeated exposure to training data. In unsupervised learning, a self-organizing algorithm learns previously unknown patterns in a data set without any provided labels. In supervised learning, this training data includes an input that is labeled (either automatically, or by a human annotator) with a “ground truth” of the output that corresponds to the input. A portion of the training data set is typically held out of the training process for purposes of evaluating/validating performance of the trained model. The use of a trained model in production is often referred to as “inference,” during which the model receives new data that was not in its training data set and provides an output based on its learned parameters. The training and validation process may be repeated periodically or intermittently, by using new training data to refine previously learned parameters of a production model and deploy a new production model for inference, in order to mitigate degradation of model accuracy over time.

For generative machine learning models, the “inference” may be the output predicted by the generative machine learning model to satisfy a language prompt (e.g., create a summary of a draft financial plan). A prompt may be an instruction and/or input text in one (or more) languages (e.g., in a programming language). Different generative machine learning models may be trained to handle varying types of prompts. Some generative machine learning models may be generally trained across a wide variety of subjects and then later fine-tuned for use in specific applications and subject areas. Fine-tuning refers to further training performed on a given machine learning model that may adapt the parameters of the machine learning model toward specific knowledge areas or tasks through the use of additional training data. For example, an LLM may be trained to recognize patterns in text and generate text predictions across many different scientific areas, literature, transcribed human conversations, and other academic disciplines and then later fine-tuned to be optimized to perform language tasks in a specific area.

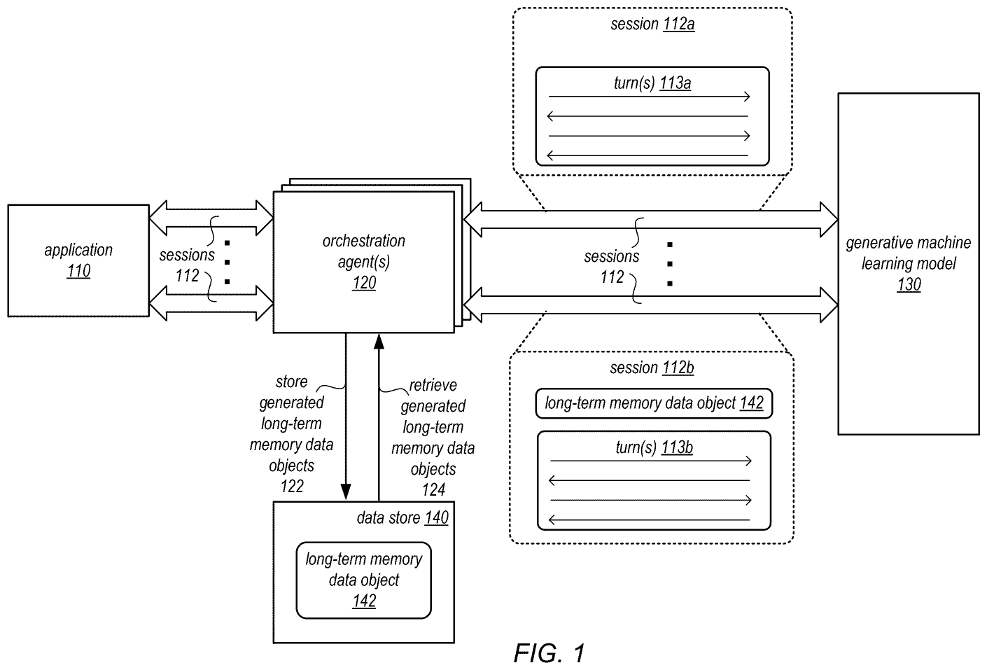

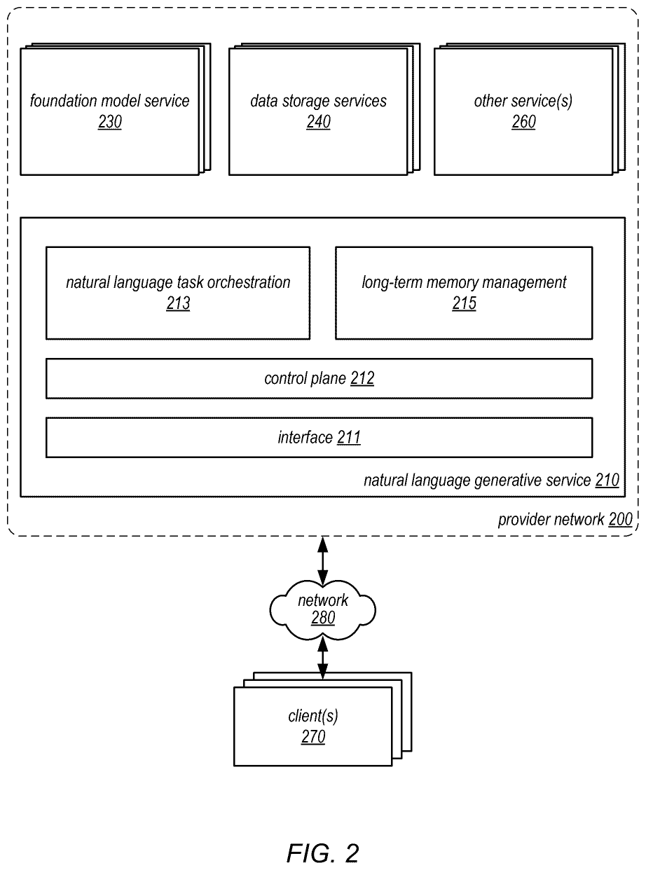

FIG. 1 illustrates a logical block diagram illustrating generating long-term memory for orchestration agent sessions, according to some embodiments. Orchestration agent(s) 120 may be one or more software applications that serve as an intermediary between a client application 110 (e.g., a web-browser, software tool or application, including text, code, or other development tools, etc.) that can facilitate individual sessions 112 with a generative machine learning model 130. In at least some embodiments, generative machine learning model 130 may be hosted as a stand-alone model or, as depicted in FIGS. 2-6B, as part of a foundation model service implemented as part of a provider network.

In at least some embodiments, orchestration agent(s) 120 may be implemented as part of a service, such as natural language generative service 210 discussed in detail below. In at least some embodiments, orchestration agent(s) 120 may implement respective plugins may be invoked to generate an overall response for a complex request which requires chain-of-thought reasoning, according to at least some embodiments. In an example scenario, one or more target LLM(s) (e.g., LLMs that are hosted at and accessible from an foundation model service of the kind introduced earlier) may be specified by an application developer for a particular application 110 which is built using a natural language generative service of the kind introduced above. As such, at a high level, the target LLM may be responsible for generating responses to end user queries or prompts.

An end user of application 110 may submit a complex request to application 110 via a programmatic interface (such as a web services interface with a Uniform Resource Locator or URL set up by the natural language generative service or the foundation model service for application 110), and eventually receive a final response generated with the help of the target LLM(s). From the perspective of the end user, it may appear that the request is being handled by a single entity or device implementing application 110. Behind the scenes, however, a more complex workflow may be implemented to prepare the final response in at least some embodiments.

An natural language generative service orchestration agent 120 assigned to application 110 (e.g., by a workflow orchestration agent manager of the natural language generative service) may receive the raw version of the request submitted by the end user in the depicted embodiment. The agent may generate an augmented version of the request 10066, which indicates for example an output format (e.g., a machine readable format such as JavaScript Object Notation (JSON) or the like) in which the target LLM is to provide its output, and a list of available plugins of application 110. These plugins may have been provided for application 110 by the developer of application 110, e.g., as part of the application 110 application descriptor sent to the natural language generative service by the developer.

The target LLM may be able to determine that it will be unable to generate a final response of a desired accuracy or quality without using plugins. Instead of trying to provide the final response immediately, the target LLM may therefore decompose request into lower-level sub-requests or sub-queries, and obtain answers for the sub-queries with the help of the plugins as it attempts to build up or reach the final response using chain-of-thought reasoning. The terms sub-request, sub-task, and sub-query may be used interchangeably herein.

In at least one embodiment, the target LLM (e.g., generative machine learning model 130) may generate an answer or response to a first sub-query, and send the sub-query and its response to the orchestration agent 120. In some cases, the target LLM may identify that a second sub-query (generated for example based on the answer to the first sub-query) is to be sent to plug-in. The agent may then send the second sub-query to the plug-in. A response from the plug-in may be received at the agent and/or the target LLM, and the target LLM context for responding to request may be updated dynamically with this response. The target LLM may then send the agent an indication of a second sub-query (generated for example from the combination of results of the earlier sub-queries) to be sent to a second plug-in. A response from the second plug-in may be received and used to update the LLM context. A third sub-query may then be sent with the help of the orchestrator to a third plug-in, and so on. Eventually the accumulated responses to the set of sub-queries may provide the target LLM sufficient information for it to generate the final response. In some cases, the final response may be sent to the end user by the agent rather than from the target LLM; in other cases, the final response may be sent directly from the target LLM. Note that in some embodiments, an orchestration agent 120 may itself comprise one or more LLMs of an foundation model service. In one embodiment, one or more plugins may utilize or invoke LLMs.

In at least one embodiment, client application 110 may start a session with an orchestration agent and perform one or more turns (e.g., sending text inputs and receive text responses, which may be generated by generative machine learning model 130 (as discussed in the example above)). In at least one embodiment, a session may be established using a connection or other network protocol. In at least one embodiment, a session may be a sticky session, where a client application 110 hosted on another system can communicate with a same orchestration agent for each communication transmitted to and received from orchestration agent 120. In at least one embodiment, a session may be ended or otherwise complete when an explicit session termination protocol is followed (e.g., as a result of a client application 110 initiating the session termination protocol) and/or in the event of a network failure, application failure, orchestration failure, application timeout or other period of time where no communications are received.

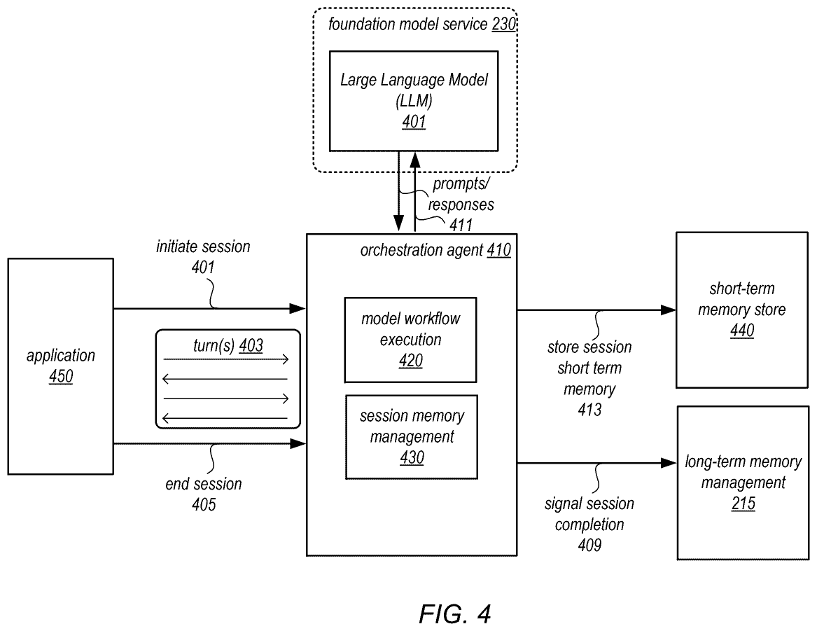

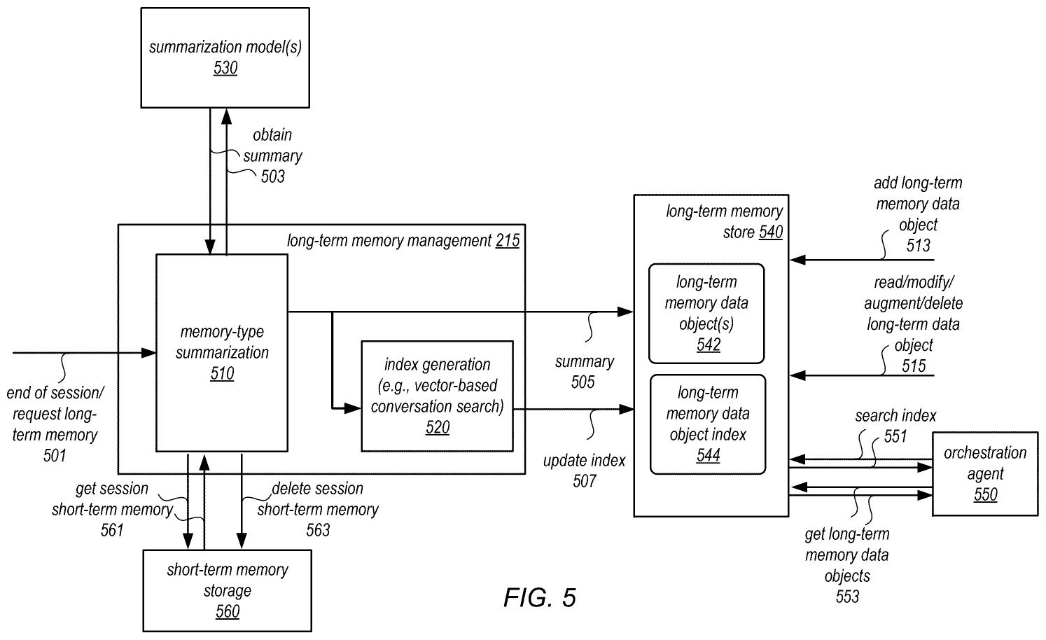

When a session completes, orchestration agent(s) 120 may generate (or use another system to generate as depicted in FIGS. 4 and 5, long-term memory data object(s) 142 to store, as indicated at 122. These long term memory data object(s) may be later retrieved and used to inform and improve a subsequent session. For example, an initial session 112a may include one or more turn(s) 113a. Based on turns 113a, a long term memory data object may be created and retrieved, as indicated 124 and used in a subsequent session 112b (e.g., provided as input 142) along with one or more turns 113b of the new session). In this way, the long-term memory data object 142 can be used to reduce the amount of repeat information or context that has to be provided by an application in a new and related sessions. The following examples illustrate improvements offered by included long-term memory data objects into a new session.

In example 1, The end user has a first conversation in session 1 but, without achieving their goal, they had to drop. The same user then comes back, starts a new session(session 2), they can see the previous conversation history and they continue the task from where they left it.

### Example 1

### Session 1:

System: User logged in
Assistant: Hello! How can I assist you today?
User: Hi. I want to find a nice place to eat dinner with my partner.
Assistant: Sure I can help with that. What do you prefer? A quiet place or something else like places where you can dance?
User: Some quiet place but now I need to go. We can continue later.

### Session 2:

[[long-term memory: User logged in and asked to find a nice place to eat dinner with partner that was quiet]]
System: User logged in
Assistant: Welcome back! How can I help you? Are you still looking for booking a table for dinner?
User
: Yes. Do you have suggestions?
Assistant
: Yes, there is a nice and quiet place called Restaurant ABC.
User: Ok, can you please book a table for two people for today at 7.30 pm?
Assistant: Your table is booked.

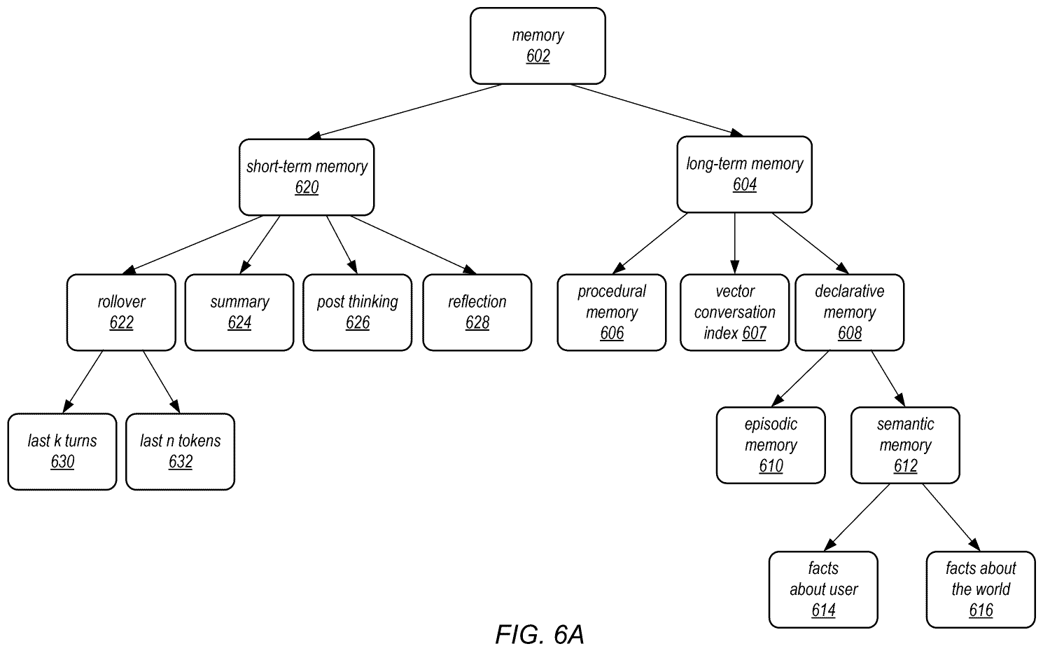

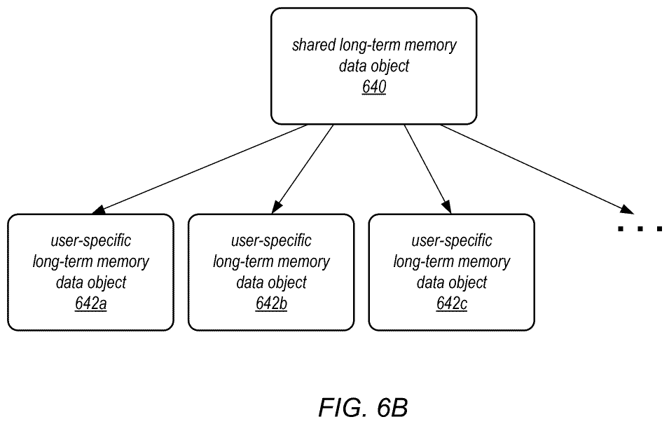

In various embodiments, long-term memory may be different than short-term memory (as discussed below with regard to FIG. 6A). For example, short term memory may be the history of various inputs or turns in a session, in some embodiments, whereas long-term memory may be inputs or other context from a prior session stored and associated with a new session when that new session is initiated. Different types of long-term memory may be used, as discussed below, which may be specified so that corresponding types of long-term memory are generated and stored for use in later sessions. In this way, developers can select the appropriate information to shape the interactions with a generative machine learning model 130.

Please note that the previous description is a logical illustration and thus is not to be construed as limiting as to the implementation. Different combinations or implementations may be implemented in various embodiments.

This specification begins with a general description of a provider network that implements a generative natural language service that supports distributed orchestration of natural language tasks using a generative machine learning model and generating long-term memory for orchestration agent sessions. Then various examples of distributed orchestration of natural language tasks using generating long-term memory for orchestration agent sessions including different components, or arrangements of components that may be employed as part of implementing the service are discussed. A number of different methods and techniques to implement generating long-term memory for orchestration agent sessions are then discussed, some of which are illustrated in accompanying flowcharts. Finally, a description of an example computing system upon which the various components, modules, systems, devices, and/or nodes may be implemented is provided. Various examples are provided throughout the specification.

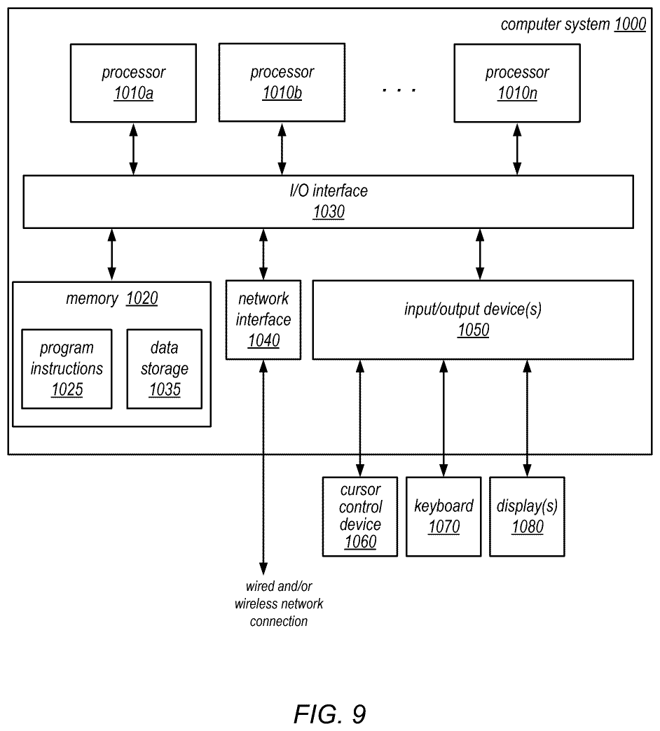

FIG. 2 is a logical block diagram illustrating a provider network offering a natural language generative service that implements generating long-term memory for orchestration agent sessions, according to some embodiments. Provider network 200 may be a private or closed system or may be set up by an entity such as a company or a public sector organization to provide one or more services (such as various types of cloud-based storage) accessible via the Internet and/or other networks to clients 270, in some embodiments. Provider network 200 may be implemented in a single location or may include numerous data centers hosting various resource pools, such as collections of physical and/or virtualized computer servers, storage devices, networking equipment and the like (e.g., computing system 1000 described below with regard to FIG. 9), needed to implement and distribute the infrastructure and services offered by the provider network 200. In some embodiments, provider network 200 may implement various computing systems, platforms, resources, or services, such as a natural language generative service 210, compute services, foundation model service 230, data storage service(s) 240, (e.g., relational or non-relational (NoSQL) database query engines, map reduce processing, data flow processing, and/or other large scale data processing techniques, an object storage service, block-based storage service, or data storage service that may store different types of data for centralized access), data stream and/or event services, and other services (any other type of network based services (which may include various other types of storage, processing, analysis, communication, event handling, visualization, and security services not illustrated), including other service(s) 260.

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 9 and described below. In various embodiments, the functionality of a given system or service component (e.g., a component of data storage service 230) may be implemented by a particular node or may be distributed across several nodes. In some embodiments, a given node may implement the functionality of more than one service system component (e.g., more than one data store component).

In various embodiments, natural language generative service 210 may provide a scalable, serverless, and machine-learning powered service to create or support generative natural language applications allowing developers to create and configure orchestration agents for interacting with generative machine learning models to perform natural language tasks, including chat sessions and other tasks triggered by or invoked by commands or requests received in natural language, such as through a chat session. Natural language generative service 210 may enables users (e.g., enterprise customers) to deploy a generative AI-powered “expert” in minutes. For example, users (e.g., enterprise employees or agents) can ask complex questions via applications that operate on enterprise data, get comprehensive answers and execute actions on their enterprise applications in a unified, intuitive experience powered by generative AI.

Natural language generative service 210 easily connects to a variety of different systems, services, and applications, both hosted internal to provider network 200 and external to provider network 200 (e.g., other provider network/public cloud services or on-premise/privately hosted systems). Once connected, natural language generative service 210 allows users to ask complex questions and execute actions on these systems using natural language (e.g., human speech commands). For example, a sales agent can ask the generative application to compare the various credit card offers and recommend a card with the best travel points for their customer and natural language generative applications service 210 would support the features to provide a recommendation and the reason for its choice along with references to the data sources for this recommendation. In some scenarios, a user can use the generative application to create a case summary and add it to a customer relationship management (requestM) system.

Natural language generative service 210 may implement security layers that check user permissions to prevent unauthorized access to enterprise systems thereby ensuring users only see information and perform actions they are entitled to. Natural language generative service 210 implements guardrails to protect against and avoids incorrect or erroneous statements or other generated results (sometimes called hallucinations) by limiting the responses to data in the enterprise and builds trust by providing citations and references to the sources used to generate the answers. Natural language generative service 210 may offer an intuitive user interface to create and deploy an enterprise-grade application to users in minutes without requiring generative machine learning domain expertise.

For example, enterprises are struggling to provide new generative AI-powered experiences that their users expect while interacting with enterprise systems. Users may need to switch across multiple fragmented systems like internal wiki, various data share sites, communication sites or messaging services in order to find information because they cannot get comprehensive answers collated from ideas contained in multiple pieces of content. Moreover, users are unable to ask probing follow-up questions or perform comparative analysis on the content to understand it better. When users need to take any follow-up actions, users then need go through multiple platforms like requestM systems, ticketing systems and other enterprise applications to take the action.

Recent advancements in generative AI powered by machine learning models trained to generate content (referred to as generative machine learning models), such as generative language models, like Large Language Models (LLMs), have opened up possibilities to build intuitive expert-like experiences. However, these generative models have limitations as they are not knowledgeable about enterprise data and their knowledge is not up to date. Generative models also hallucinate and there is no way for end users to fact-check the responses. Additionally, enterprises need to ensure that users do not get answers from content that they do not have access to. Enterprises may also need to build a conversational application and deploy it for their users. This makes it hard to adopt the new generative AI technologies for enterprise use cases. Lack of unified, intuitive experiences for the enterprise leads to poor knowledge sharing among the users, lower rate of self-service, and loss of productivity across the company.

With natural language generative service 210, enterprises (and other service users) utilize the various features of natural language generative service 210 to overcome the technical challenges standing in the way of enterprises to make use of generative AI. Natural language generative service 210 allows enterprises to easily tap into the power of AI technologies, including generative AI, to transform how their users interact with their enterprise applications in a secure way. Natural language generative service 210 moves beyond the traditional fragmented experience of navigating multiple systems to a single, unified expert-like experience. Using an intuitive interface elements (e.g., a simple point-and-click admin interface), application creators (e.g., for enterprises) can sync with enterprise systems. Users of the generative applications benefit from capabilities like generative answers from multiple documents, answers from knowledge embedded in the model, comparative analysis, content summarization, math and reasoning, text generation and ability to execute actions on enterprise apps. Natural language generative service 210 may support requests to find information and execute follow-up actions (e.g., “find me policy options for this client and attach a summary to client notes in a requestM system”). Natural language generative service 210 uses enterprise content to generate answers thus minimizing hallucinations and providing up-to-date information. To ensure trust and safety for the users, Natural language generative service 210 weaves in human-like citations, references, and attachments for source documents in its response. Natural language generative service 210 manages enterprise access and access control list (ACL) permissions. When the user asks a question to natural language generative service 210, natural language generative service 210 analyzes the data in the enterprise systems and generates responses only from the content that the user has access to. Natural language generative service 210 also provides a pre-built conversational application that can be easily deployed for end users in minutes speeding up the time to value for application creators. The unified and intuitive experience provided by natural language generative service 210 improves productivity and knowledge sharing for enterprises and enhances self-service for end users.

In various embodiments, application creators can deploy generative applications that can utilize natural language generative service 210 in their enterprise in minutes. For example, in a console or other graphical user interface, creators can quickly connect their enterprise systems to natural language generative service 210. Natural language generative service 210 provides a wide range of built-in data connectors to different data sources to associate them as data repositories for a generative application and supports data retrievers, which find relevant data (e.g., documents or other non-natural language data, such as image data, numerical data, audio or video data) to feed into a generative machine learning model (e.g., an LLM). Natural language generative service 210 also supports actions for enterprise systems such as updating a customer record in a database or creating a ticket in an issue management system so that users can execute actions in those applications using natural language commands. Next, application creators can connect their generative applications with their identity providers (e.g., both internal to, or external to, provider network 200)., etc. Finally, application creators can deploy the pre-built conversational application to their end users.

Natural language generative service 210 may support interactions through a an orchestration agent created in order to perform various tasks, which may be specified in natural language request received via a client application. Features of natural language generative service 210 to support these interactions may include question answering for enterprise data. For instance, natural language generative service 210 can process questions from end users and returns generative responses using information from various secure enterprise data sources. Natural language generative service 210 can continue the conversation with the user in the context of the active session or start with a new one. Natural language generative service 210 will support question answering on both structured and unstructured data sources. Application creators (e.g., which may be enterprise administrators) can choose if they want to limit answers from enterprise content or leverage the knowledge of the generative model to answer queries.

Another example feature of natural language generative service 210 to support interactions may be actions. Natural language generative service 210 enables end users to perform actions on various applications like email, messaging, posting or other communication or data sharing applications using natural language commands. For example, an end user can ask natural language generative service 210 to update an opportunity in a requestM system or create a ticket in a ticketing system.

Another example feature of natural language generative service 210 to support interactions is summarization. End users can also ask for a summary of the content in their chat.

Natural language generative service 210 supports various creation user interfaces, including programmatic, API or software development kit (SDK), and/or graphical user interfaces, such as a hosted web-console. For example, a web-console of natural language generative service 210 may provide an easy way to get started. An application creator can point natural language generative service 210 to content sources and use the experience builder to quickly deploy a pre-built user interface for end users. An application creator can also apply customization such as response tuning, custom document enrichment, and custom synonyms, to further improve answer accuracy, as noted above. Natural language generative service 210 can also be integrated with non-hosted applications using APIs.

Natural language generative service 210 natural language capabilities enable it to understand any business domain or specialty. However, for application specific vocabulary (e.g., specific to a particular enterprise), application creators can use natural language generative service 210's custom synonyms feature to tune natural language generative service 210so that it can recognize those words.

Natural language generative service 210 may provide support to access various types of data files and formats, including but not limited to, PDF, HTML, slide presentation files, word processing files, spreadsheet files, Javascript Object Notation (JSON), Comma Separated Value (CSV), Rich Text Files (RTFs), plain text, audio/video, images and scanned documents. Natural language generative service 210 may support many different human languages for interacting performing natural language tasks.

Natural language generative service 210 may securely store application data and uses it only for the purpose of providing the service to the application's end-users. The data may be encrypted using service-provided keys or application creator provided keys.

Natural language generative service 210 may implement front-end 211, in some embodiments. Front-end 211 may support various types of programmatic (e.g., Application Programming Interfaces (APIs)), command line, and/or graphical user interfaces to support the management of data sets for analysis, request, configure, and/or otherwise obtain new or existing analysis, and/or perform natural language queries, as discussed below. Front-end 211 may be a service that an application creator (or application owner) will use to configure and build custom applications (e.g., for generative AI-powered conversation). For example, front-end 211 may support HTTPS/2 for streaming use cases and fall back to HTTPS/1 .1 for non-streaming use cases, in some embodiments. In some embodiments, front-end 211 may have browser support for API, with web-socket support for the streaming interface. In various embodiments, front-end 211 may implement throttling, metering, ensuring authentication and authorization.

Front-end 211 may dispatch requests (and/or proxy for) downstream services of natural language generative services (e.g., control plane 212, natural language task orchestration 213 and long-term memory management 215).

Natural language generative service 210 may implement control plane 212, in some embodiments. Control plane 212 may be a service which will store and manage the top level account for a generative application (or multiple generative applications that may be created under an account). Control plane 212 may also be a single point service for handling data protection regulation (e.g., GDPR), resource identification and tagging from other provider network 200 services, and requests for operations such as deletion of top level resources. Control plane 212 may orchestrate the actions across other services of natural language generative service 210, such as natural language task orchestration 213 and long-term memory management 215.

Natural language generative service 210 may implement natural language task orchestration 213, in some embodiments. Natural language task orchestration 213 may execute workflows to perform natural language tasks received as natural language requests, as discussed above and in detail below with regard to FIG. 4. For example, natural language task orchestration may include various sub-components, systems, or microservices that can, among other operations, take request input along with information such as user id and filtering criteria and running them through a orchestration process, that includes, but is not limited to, ensuring that the query input is free from profanity, getting the conversation context from session store, query re-writing and generation, retrieving one or more results from retrieval service, sending the information through to a generative machine learning model, and sending the information through some response classifier to ensure that response is free from bias, profanity and slur. In at least some embodiments, natural language task orchestration may support the use of sessions, which may include the generation of long-term memory, as discussed in detail below.

In various embodiments, foundation model service 230 may provide access to numerous foundation models (FMs). A foundation model (FM) may be a privately developed or maintained machine learning model, which may use millions or billions of parameters. FMs may include LLMs as well as multi-modal language models (MMLMs) such as vision-language models or VLMs. For example, a baseline or core FM collection of the foundation model service 230 may include TP1 LLM, TP2 MMLM, foundation model service 230 LLM and foundation model service 230 MMLM, among others. TP1 LLM may be a large language model developed/designed by a third party TP1; that is, by an entity other than the operator of the foundation model service 230 and other than the end users who may utilize TP1 LLM for inference using programmatic interfaces of the foundation model service 230. TP2 MMLM may have been pre-trained using multiple modes of input data, including for example a combination of text and video/images. foundation model service 230 LLM may be designed/developed by the organization which implements the foundation model service 230 (such as the operator of a cloud provider network), and may also be referred to as a first-party or 1P LLM. foundation model service 230 MMLM may also be designed/developed by the organization which implements the foundation model service 230.

Data obtained from a variety of data sources may be used to pre-train (and in some cases fine tune) foundation machine learning models (FMs) to which access is provided by the foundation model service 230. The data sources may include, among others, portions of web crawl results obtained from subsets of the public Internet, publicly accessible source code repositories, as well as data corpuses that are not publicly accessible via the Internet.

The foundation model service 230 may comprise a number of subcomponents, each implemented using some combination of hardware and software at one or more computing devices. One or more third-party model registration managers may coordinate workflows for adding third party FMs to the foundation model service 230, e.g., including approving (or rejecting) registration requests for new third party FMs based on a set of acceptance criteria of the foundation model service 230. Data processing managers may be responsible for implementing a pipeline of transformations and filtering operations on input data that may be used for pre-training an FM, and for ensuring that the data used for such pre-training meets quality criteria of the foundation model service 230. Training coordinators may, for example, implement a number of techniques for parallelizing pre-training of FMs, e.g., using a set if resources of a pre-training resources pool. Fine tuning coordinators may utilize resources of a fine-tuning resource pool to customize pre-trained FMs at the request of the FM owners/developers in some embodiments. In at least some embodiments, fine-tuned FMs may also be made accessible to end users via the programmatic interfaces. In at least some embodiments, the foundation model service 230 may provide an indication, via programmatic interfaces) of all the different FMs that are available for end users.

After an FM is pre-trained and/or fine-tuned, end user requests for inference using the FM may be processed in various embodiments at the foundation model service 230. One or more inference coordinators may utilize resources of inference resource pool to execute the FMs and generate inference results that can be provided via the programmatic interfaces in the depicted embodiment. Model metadata repository may be used to store information such as the dates at which various FMs were pre-trained or fine-tuned, the data sets used for pre-training or fine-tuning, restrictions/permissions specified by the FM owners on the use of their FMs, performance metrics collected during pre-training, fine-tuning, or inference, and so on. In some embodiments model metadata repository 135 may also be used to store preferences of FM owners/developers regarding aspects such as targeted high availability levels, targeted types of hardware accelerators for training/inference, and so on. In one embodiment, as described below in further detail, reinforcement learning from human feedback (RLHF) may be employed as one of the stages of preparing a given FM. The operator of the foundation model service 230 may have staff trained for providing the feedback used for RLHF, and one or more RLHF coordinators may organize access to such staff in various embodiments. In various embodiments the foundation model service 230 may also include a set of control plane or administrative nodes, responsible (among other tasks) for monitoring the health and status of some or all of the other subcomponents of the foundation model service 230, provisioning resources as needed for the other subcomponents, and so on. The control plane components are not shown in FIG. 1.

A number of auxiliary services may utilize the foundation model service 230 in various ways in some embodiments. For example, in some embodiments, results generated by an FM hosted at the foundation model service 230 may be fed as input to perform one or more tasks at an auxiliary service, such as generative machine learning service 210. In another embodiment, an LLM-based application development service may be implemented, in which chain-of-thought reasoning may be used to perform multi-step tasks.

In various embodiments, the foundation model service 230 may implement a set of programmatic interfaces, such as one or more web-based consoles, command-line tools, graphical user interfaces and/or application programming interfaces (APIs). The programmatic interfaces may be utilized by foundation model service 230 customers of several different classes. One class of customers may include, for example, FM developers/designers who wish to utilize the foundation model service 230 for registering their LLMs, processing input data to train other LLMs, fine-tuning their LLMs, and so on. Another class of customers may include end users who wish to obtain inference results from LLMs hosted by the foundation model service 230. Requests may be submitted to the foundation model service 230 via the programmatic interfaces by the various classes of customers from client devices (such as laptops, desktops, mobile devices, phones and the like), and responses may be provided to the client devices from the foundation model service 230.

Data storage service(s) 240 may implement different types of data stores for storing, accessing, and managing data on behalf of clients 270 as a network-based service that enables clients 270 to operate a data storage system in a cloud or network computing environment. database services 230 may be various types of data processing services that perform general or specialized data processing functions (e.g., analytics, big data querying, time-series data, graph data, document data, relational data, structured data, or any other type of data processing operation) over data that is stored across multiple storage locations, in some embodiments. For example, in at least some embodiments, database services 210 may include various types of database services (e.g., relational) for storing, querying, and updating data. Such services may be enterprise-class database systems that are scalable and extensible. Queries may be directed to a database in database service(s) 230 that is distributed across multiple physical resources, as discussed below, and the database system may be scaled up or down on an as needed basis, in some embodiments. The database system may work effectively with database schemas of various types and/or organizations, in different embodiments. In some embodiments, clients/subscribers may submit queries or other requests (e.g., requests to add data) in a number of ways, e.g., interactively via an SQL interface to the database system or via Application Programming Interfaces (APIs). In other embodiments, external applications and programs may submit queries using Open Database Connectivity (ODBC) and/or Java Database Connectivity (JDBC) driver interfaces to the database system.

In some embodiments, data storage services 240 may be various types of data processing services to perform different functions (e.g., query or other processing engines to perform functions such as anomaly detection, machine learning, data lookup, or any other type of data processing operation). For example, in at least some embodiments, data storage services 240 may include a map reduce service that creates clusters of processing nodes that implement map reduce functionality over data stored in one of data storage services 240. Various other distributed processing architectures and techniques may be implemented by data storage services 240 (e.g., grid computing, sharding, distributed hashing, etc.). Note that in some embodiments, data processing operations may be implemented as part of data storage service(s) 240 (e.g., query engines processing requests for specified data).

For example, one data storage service 240 may be implemented as a centralized data store so that other data storage services may access data stored in the centralized data store for processing and or storing within the other data storage services, in some embodiments. Such a data storage service 240 may be implemented as an object-based data store, and may provide storage and access to various kinds of object or file data stores for putting, updating, and getting various types, sizes, or collections of data objects or files. Such data storage service(s) 240 may be accessed via programmatic interfaces (e.g., APIs) or graphical user interfaces. A data storage service 240 may provide virtual block-based storage for maintaining data as part of data volumes that can be mounted or accessed similar to local block-based storage devices (e.g., hard disk drives, solid state drives, etc.) and may be accessed utilizing block-based data storage protocols or interfaces, such as internet small computer interface (iSCSI).

In various embodiments, data stream and/or event services may provide resources to ingest, buffer, and process streaming data in real-time, which may be a source of data repositories. In some embodiments, data stream and/or event services may act as an event bus or other communications/notifications for event driven systems or services (e.g., events that occur on provider network 200 services and/or on-premise systems or applications).

Generally speaking, clients 270 may encompass any type of client configurable to submit network-based requests to provider network 200 via network 280, including requests for materialized view management platform 210 (e.g., a request to create a generative application at natural language generative service). For example, a given client 270 may include a suitable version of a web browser, or may include a plug-in module or other type of code module that may execute as an extension to or within an execution environment provided by a web browser. Alternatively, a client 270 may encompass an application such as a generative application (or user interface thereof), in provider network 200 to implement various features, systems, or applications. (e.g., to use natural language generative service 210 APIs to send natural language requests to perform different tasks (e.g., question answering, summarization, or various other features as discussed above). In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 270 may be an application may interact directly with provider network 200. In some embodiments, client 270 may generate network-based services requests according to a Representational State Transfer (REST)-style network-based services architecture, a document- or message-based network-based services architecture, or another suitable network-based services architecture.

In some embodiments, a client 270 may provide access to provider network 200 to other applications in a manner that is transparent to those applications. For example, client 270 may integrate with an operating system or file system to provide storage on one of data storage service(s) 240 (e.g., a block-based storage service). However, the operating system or file system may present a different storage interface to applications, such as a conventional file system hierarchy of files, directories and/or folders. In such an embodiment, applications may not need to be modified to make use of the storage system service model. Instead, the details of interfacing to the data storage service(s) 240 may be coordinated by client 270 and the operating system or file system on behalf of applications executing within the operating system environment.

Clients 270 may convey network-based services requests (e.g., natural language queries) to and receive responses from provider network 200 via network 280. In various embodiments, network 280 may encompass any suitable combination of networking hardware and protocols necessary to establish network-based-based communications between clients 270 and provider network 200. For example, network 280 may generally encompass the various telecommunications networks and service providers that collectively implement the Internet. Network 280 may also include private networks such as local area networks (LANs) or wide area networks (WANs) as well as public or private wireless networks. For example, both a given client 270 and provider network 200 may be respectively provisioned within enterprises having their own internal networks. In such an embodiment, network 280 may include the hardware (e.g., modems, routers, switches, load balancers, proxy servers, etc.) and software (e.g., protocol stacks, accounting software, firewall/security software, etc.) necessary to establish a networking link between given client 270 and the Internet as well as between the Internet and provider network 200. It is noted that in some embodiments, clients 270 may communicate with provider network 200 using a private network rather than the public Internet.

As noted above, natural language generative service 210 may support communications with external data sources 290 over network 280 in order to obtain data for performing various natural language tasks.

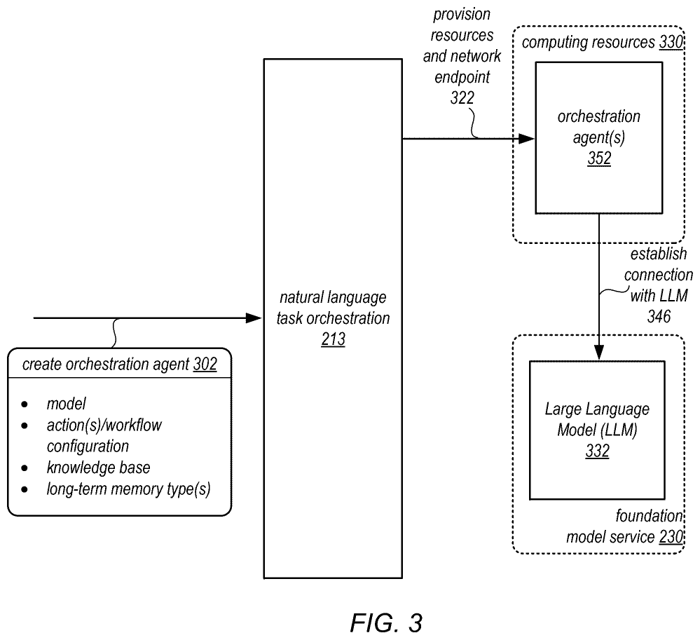

FIG. 3 is a logical block diagram illustrating interactions to create an orchestration agent and specify a long-term memory type at the natural language generative service, according to some embodiments. As indicated at 302, a request to create an orchestration agent may be received. The request 302 may include a model (e.g., a FM of foundation model service 230 or other generative machine learning model), a workflow or action(s) to execute to facilitate response or interact with inputs during a session (e.g., a chat session), a knowledge base (e.g., a database or other data repository which may provide application specification information for performing workflows or providing context), and a long-term memory type (e.g., one or more of the long-term memory types discussed below with regard to FIG. 6A). In some embodiments, request 302 may specify a duration for maintaining the long-term memory.

Natural language task orchestration 218 may provision one or more computing resources 330 to host orchestration agent(s) 352 and configure them according to request 302. For example, orchestration agent(s) 352 may establish a connection with an LLM 332 of foundation model service 230 to use for subsequent interactions, as discussed below. Natural language task orchestration 213 may configure, install, load, or otherwise prepare orchestration agent(s) 352 to execute specified action(s) and/or workflows. Natural language task orchestration 213 may setup or enable long-term memory generation for specified long-term memory type(s) in request 302 (as exemplified in FIG. 6A). Natural language task orchestration 218 may configure a network endpoint (e.g., a network address) that routes requests to orchestration agent(s) 352.

FIG. 4 is a logical block diagram illustrating interactions to capture session short term memory, according to some embodiments. Application 450 (which may be a client application hosted as part of another service of provider network 200, or remote from/external to provider network 200) may initiate a session 401 (e.g., using an API or other command supported by orchestration agent 410). Through one or more turn(s) 430 providing input to orchestration agent 410, model workflow execution 420 may take action(s) and submit and receive various prompt(s) and responses 411 from LLM 401 of foundation model service 230. As the turn(s) 403 are received, session memory management 430 of orchestration agent 410 may store as part of a short term memory for the session, as indicated at 413, turn inputs and responses (and other information obtained or retrieved as part of performing actions and/or workflow(s)) as part of short-term memory store 440 (e.g., data object store or database of data storage services 240).

Application 450 may signal the end of the session, as indicated at 405. Session memory management 430 may signal the completion of the session, as indicated at 409, to long-term memory management 215, which may generate a long-term memory data object according to one or more long-term memory types, as discussed in detail below with regard to FIG. 5.

Memory type summarization 510 may get the session short term memory 561 from short term memory storage 560 and obtain the summar(ies) 530 as indicated 503. Summary 505 may be provided and stored as part of long-term memory store 540 (e.g., one of data storage services 240), in some embodiments. In one embodiment, long-term memory store 540 may be managed by natural language generative service 210. In another embodiment, long-term memory store 540 may be controlled, operated, or maintained by an account of natural language generative service 210 (e.g., in a data storage service 240 data store used by the same account). In some embodiments, an index may be maintained for long-term memories in order to identify relevant long-term memories for subsequent sessions. For example, a summary 505 may be encoded at index generation 520 into a latent or feature space (e.g., encoding as an embedding or vector using a text encoder for the summary) and added to long-term memory data object index 544, as indicated at 507. In this way, a search 551 (e.g., by orchestration agent 550 or other components) can be performed using the feature space to identify relevant memories, in some embodiments.

In at least one embodiment, vector index long-term memory types may be created using an encoder or other machine learning model that may be trained to encode turn inputs (e.g., as depicted in FIG. 4) as chunks or other portions of one or more turns into a feature (or embedding) space. Each chunk may be encoded as a vector and stored as an entry long-term memory data object index 544, which may be implemented as a vector database or other vector data store. In this way, a vector conversation index long-term memory type for long term memory data object(s) 542 may be created that can be searched using one or more requests in order to augment or add to a prompt with a corresponding decoded portion of the previous turn. For example, orchestration agent 550 may determine that a vector conversation index long-term memory type is specified or supported for a session and obtain information as part of the current session (e.g., an initial question, identifying information, and/or other long-term memory information from other long-term memory data types determined for the session) to determine one or more query vectors to search long-term memory data object index 544 (e.g., encoding a term, phrase, or other input using the same encoder as used to create the vector conversation index) using cosine or other vector similarity techniques. A top-n (e.g., n>=1) results using the similarity between the query vector and stored vectors for different chunks or portions of the vector conversation index may be provided back to orchestration agent 550 to use as input (or to generate input) to be included in a request to an LLM as part of the session. In at least one embodiment, memory-type summarization 510 and index generation 520 may be implemented separately from long-term memory management 215 (not illustrated) and may be accessed by both short-term memory management and long-term memory management features, like long-term memory management 215, which may allow for memory-type summarization to create embeddings for chunks or other portions of short term memory for a session (as discussed above) and store it either in long-term memory store 540 or as part of a separate data store for vector-based conversation search.

Long-term memory management 215 may delete session short term memory, as indicated at 563, in some embodiments, when a long-term memory data object 542 has been created. As indicated at 513, in some embodiments a request to add a long-term memory data object may be performed (e.g., adding a long-term memory object created by or for another application that is relevant to another application that uses long-term memory data object(s) 542). In at least some embodiments, a request to modify or augment a long-term data object 515 may be performed (e.g., adding further context, user, session, background, or other information, or changing altering information, such as to remove personal or other information to satisfy data retention regulations or requirements). A request to ready long-term data objects may be supported, as indicated at 515 (e.g., to read or obtain copies of summaries). A request to delete long-term memory data object(s) 542 may also be supported, as indicated at 515.

As indicated at 513, orchestration agent 550 may get a long-term data object 553 (or multiple) to use for performing subsequent sessions (as discussed in detail above with regard to FIG. 1). For example, episodic, procedural, semantic and/or vector conversation index (as discussed above) may be used to generate prompts (or add context to prompts) as part of a session. Different long-term memory types may be used in different ways according to the application that makes use of the long-term memory and orchestration agent 550.

In at least one embodiment, data stored for accounts (e.g., customers, users, or other entities that make use of natural language generative service 210), may be stored in service storage (e.g., short-term memory store 440 and/or long-term memory store 540) and/or account associated storage (e.g., storage databases, buckets, files, objects or other structures in other provider network services, such as storage services 240, or on-premises storage systems. In at least one embodiment, different encryption techniques may be implemented to ensure that access to memory (short or long-term) of sessions is secure, private, and restricted such that only authorized entities may access the memory. For example, different encryption techniques may be implemented, including the use of rotating encryption/decryption keys, data-specific encryption/decryption keys (e.g., for specific tables, memory objects, or other data structures), or other encryption techniques may be implemented. In at least one embodiment, envelope encryption techniques may be implemented where a first encryption key used to decrypt a second encryption key may be implemented, allowing the encryption of the second encryption key to rotate through different encryption keys while data encrypted/decrypted using the second encryption key that is “in the envelop” to be used to access underlying account data. One example, of an envelop encryption technique is the use of a hierarchical key structure, where “branch keys” in a tree structure of keys may be stored in a table, and then cached branch keys can be used in encrypt and decrypt operations. The branch key table can serve as a key store that manages and protects branch keys. The table may store the active branch key and all previous versions of the branch key. The active branch key may be the most recent branch key version. A unique data key may be used to encrypt each field and encrypts each data key with a unique wrapping key derived from the active branch key. The hierarchy of keys may be established between active branch keys and their derived wrapping keys.

FIG. 6A is a logical illustration of different types of memory for applications using orchestration agents, according to some embodiments. In at least some embodiments, memory 604 can be divided into short term memory 620 and long-term memory 604. In at least some embodiments, memory 602 may refer to history, context, actions, or other information obtained, generated, or input as part of a session. Short term memory 620 may pertain to a specific session and may include, among other examples, rollover 622, such as the last k turns 630 and last n tokens 532, summary 624, post thinking 626, and reflection 628.

In at least some embodiments, long-term memory 604 may include a detailed history (e.g., a copy of short term memory 620) and/or a summary generated according to one or more long-term memory types. Procedural memory 606 (which may have some similarity to “subconscious memory”), for example, may be recall of skills, habits, and procedures that guide actions and behaviors for executing a workflow. Declarative memory 608 (which may have some similarity to “conscious” memory) may include both episodic memory 610 and semantic memory 612. Semantic memory 612 may, for example, be general knowledge about the world 616 and user(s) 614, such as likes, dislikes, or preferences. Episodic memory may be, for example, memory of experiences and events, and use context about the where and when an event took place.

For example, procedural memory 606 may have use cases for learning a new skill (e.g., remembering a procedure to follow), such as for solving a particular kind of math problem. Episodic memory 610 may be, for example, useful in determining a timeline of events for scenarios that include past health records and when conditions were diagnosed, ongoing issues for customer support and how the resolution of events took place. Facts about a user 614 may have use cases to include personal preferences, such as give output in a format, color, size, or consider allergies, or a name. Facts about the world 616 may include remembering facts, such as the capital of a country.

Vector conversation index 607 may be another type of long-term memory 604. As discussed above with regard to FIG. 5, such a long-term memory type may facilitate the quick lookup of relevant portions of prior sessions (e.g., chunks or other groupings of one or more inputs) in order to facilitate the inclusion of relevant portions of prior sessions as context or otherwise guide the input as part of a current session.

FIG. 6B illustrates examples between shared and user-specific long-term memories, according to some embodiments. In at least some embodiments, long-term memory data objects, such as long-term memory data object 640 may be shared for multiple users, accounts, or other entities, while other long-term memory data objects, such as 642a, 642b, and 642c may be user-specific or only accessible a single or subset of entities. A specific user or session identifier may be assigned to sessions and used to enforce access restrictions for long-term memory data objects so that only users/accounts with appropriate access can use or access long-term memory data objects.

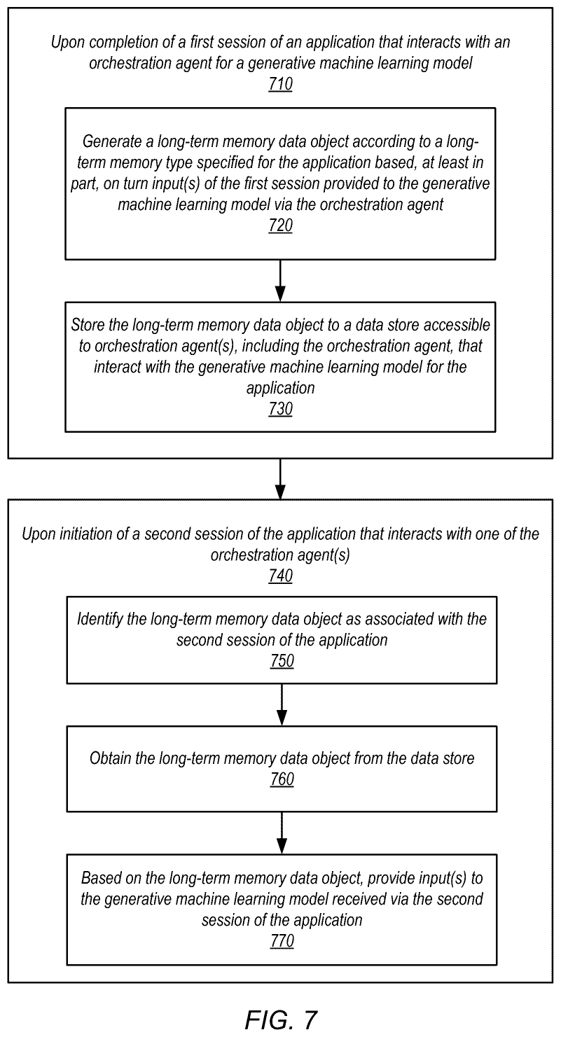

Although FIGS. 2-6B have been described and illustrated in the context of a provider network implementing a natural language generative service, the various components illustrated and described in FIGS. 2-6B may be easily applied to other systems or services that user an orchestration agent as intermediary with a generative machine learning model. As such, FIGS. 2-6B are not intended to be limiting as to other embodiments of a system that may implement natural language query processing. FIG. 7 is a high-level flowchart illustrating various methods and techniques to implement generating long-term memory for orchestration agent sessions, according to some embodiments.

Various different systems and devices may implement the various methods and techniques described below, either singly or working together. For example, a generative language service such as described above with regard to FIGS. 2-6B may implement the various methods. Alternatively, a combination of different systems and devices may implement these methods. Therefore, the above examples and or any other systems or devices referenced as performing the illustrated method, are not intended to be limiting as to other different components, modules, systems, or configurations of systems and devices.

As indicated at 710, upon completion of a first session of an application that interacts with an orchestration agent for a generative machine learning model, generate a long-term memory data object according to a long-term memory data type, in some embodiments. As discussed above with regard to FIG. 6A, different types may include episodic, procedural, and semantic long-term memory types, in some embodiments. In some embodiments, a summary (e.g., a natural language summary) of one or more turn inputs provided to the generative machine learning model as part of the first session may be used to generate the long-term memory data object. As indicated at 730, the long-term memory data object may be stored to a data store that is accessible to orchestration agent(s), including the orchestration agent, that interact with the generative machine learning model for the application. In this way, the failure of one orchestration agent does not prevent another orchestration agent from obtaining a long-term memory data object to use for a subsequent session.

As indicated at 740, upon initiation of a second session of the application with one of the orchestration agent(s), the long-term memory data object may be identified as associated with the second session of the application, as indicated at 750. In some embodiments, the long-term memory data object may be identified by a session identifier or other user-specific identifier. In some embodiments, a search of an index of long-term memory data objects may be performed to obtain one or more relevant long-term memory data objects, which may be identified as associated with the second session. As indicated at 760, the long-term memory data object may be obtained from the data store.

As indicated at 770, input(s) to the generative machine learning model received via the second session of the application may be provided based on the long-term data object, in some embodiments. For example, different types of long-term data object memory may be used to construct prompts, including further information as context to perform other inputs received as part of the session, to add or modify instructions included in a prompt, substitute or supplement features in the input data (e.g., [instruction] [first name] [instruction] may be modified to be [instruction] [first name] [last name][instruction]). A wide variety of prompt generation techniques and/or modifications may be supported given the wide range of long-term memory data types that can be used.

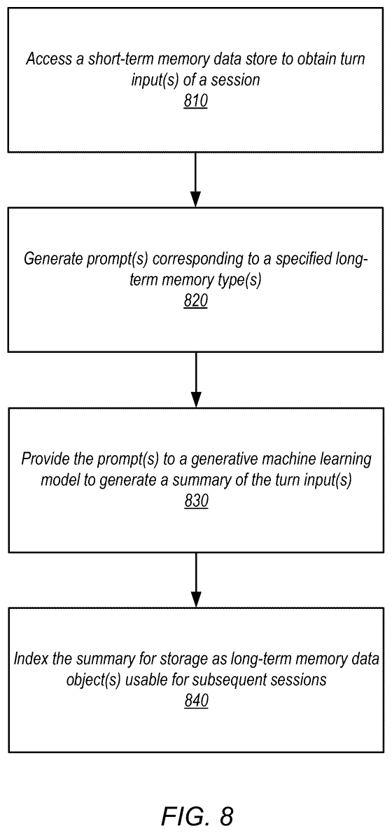

FIG. 8 is a high-level flowchart illustrating various methods and techniques to generating specified types of long-term memory for orchestration agent sessions, according to some embodiments. As indicated at 810, a short-term memory data store may be accessed to obtain one or more turn input(s) of a session, in some embodiments. For example, a specific session identifier may be used to access the correct short term session memory. As indicated at 820, a prompt corresponding to a specified long-term memory type may be generated, in some embodiments. For example, an episodic prompt (e.g., summarize the events, including when, and where, described or taken in the session), a semantic prompt (e.g., summarize any preferences described in the inputs), and/or a procedural prompt (e.g., summarize any methods or skills used in the inputs), may be used. As indicated at 830, the prompt(s) may be provided to a generative machine learning model to generate a summary of the turn input(s), in some embodiments.

As indicated at 840, the summary may be indexed for storage as a long-term memory data object for use for subsequent sessions, in some embodiments. For example, key words or other metadata, including creation time, user information, session information, or any other descriptive information may be included in or used to generate the index (e.g., which may sort, order or arrange different long-term memory data objects according to one or more of the key words or other metadata). As discussed in detail above with regard to FIG. 5, in at least some embodiments, a vector conversation index long-term memory type may be supported that uses an encoder (e.g., implemented by a neural network or other machine learning model) to encode input data, such as turn inputs, as vectors, which can then be stored and compared with query vectors to return similar turn inputs.

The methods described herein may in various embodiments be implemented by any combination of hardware and software. For example, in one embodiment, the methods may be implemented by a computer system (e.g., a computer system as in FIG. 9) that includes one or more processors executing program instructions stored on a computer-readable storage medium coupled to the processors. The program instructions may be configured to implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of generating long-term memory for orchestration agent sessions as described herein may be executed on one or more computer systems, which may interact with various other devices. One such computer system is illustrated by FIG. 9. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, computing system compute system, or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a non-transitory, computer-readable storage medium may include storage media or memory media such as magnetic or optical media, e.g., disk or CD/DVD-ROM coupled to computer system 1000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 9, memory 1020 may include program instructions 1025, may implement the various methods and techniques as described herein, and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. For example, leader nodes within a data warehouse system may present data storage services and/or database services to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
a plurality of computing devices, respective comprising at least one processor and a memory, configured to implement at natural language generative service of a provider network, comprising:
one or more orchestration agents, created and deployed via one or more requests received via an interface of the natural language generative service, wherein the one or more orchestration agents provide access for an application to a foundation model, wherein the foundation model is a large language model (LLM) trained to generate natural language;
wherein the one or more orchestration agents are configured to:
receive one or more text inputs in one or more turns in a first chat session between the application and the LLM;
upon completion of the first chat session, generate a long-term memory data object according to a long-term memory type specified for the application via the interface of the natural language generative service based, at least in part, on one or more turn inputs of the first session provided to the generative machine learning model via the orchestration agent;
store the long-term memory data object to a data store accessible to the one or more orchestration agents;
upon initiation of a second chat session of the application:
identify the long-term memory data object as associated with the second session of the application;
obtain the long-term memory data object from the data store; and
provide the long-term memory data object as part of one or more inputs to the generative machine learning model received via the second session of the application.

2. The system of claim 1, wherein to generate the long-term memory data object according to the long-term memory type, the one or more orchestration agents are configured to cause a generative machine learning model or the LLM to create a summary based, at least in part, on the one or more turn inputs.

3. The system of claim 1, wherein the one or more orchestration agents cause the long-term memory data object to be modified based, at least in part, on the one or more inputs to the generative machine learning model received via the second session of the application.

4. The system of claim 1, wherein to identify the long-term memory data object as associated with the second session of the application, the one or more orchestration agents are configured to search a long-term memory data object index to obtain the long-term memory data object.

5. A method, comprising:
upon completion of a first session of an application that interacts with an orchestration agent for a generative machine learning model:
generating a long-term memory data object according to a long-term memory type specified for the application based, at least in part, on one or more turn inputs of the first session provided to the generative machine learning model via the orchestration agent;
storing the long-term memory data object to a data store accessible to one or more orchestration agents, including the orchestration agent, that interact with the generative machine learning model for the application;
upon initiation of a second session of the application that interacts with one of the one or more orchestration agents:
identifying the long-term data memory object as associated with the second session of the application;
obtaining the long-term memory data object from the data store; and
based, at least in part, on the long-term memory data object, providing one or more inputs to the generative machine learning model received via the second session of the application.

6. The method of claim 5, wherein generating the long-term memory data object according to the long-term memory type comprises causing a different generative machine learning model or the generative machine learning model to create a summary based, at least in part, on the one or more turn inputs.

7. The method of claim 1, further comprising causing the long-term memory data object to be modified based, at least in part, on the one or more inputs to the generative machine learning model received via the second session of the application.

8. The method of claim 5, wherein identifying the long-term memory data object as associated with the second session of the application, comprising searching a long-term memory data object index to obtain the long-term memory data object.

9. The method of claim 5, wherein the long term memory type is specified in a request to create the one or more orchestration agents, causing the one or more orchestration agents to be deployed as part of a service of a provider network.

10. The method of claim 5, wherein the long term memory type is a procedural memory type.

11. The method of claim 5, wherein the long term memory type is an episodic memory type.

12. The method of claim 5, wherein the long term memory type is a semantic memory type.

13. The method of claim 5, wherein at least part of the long term data object is shared with a plurality of different user-specific long term data objects.

14. One or more non-transitory, computer-readable storage media, storing program instructions that when executed on or across one or more computing devices cause the one or more computing devices to implement:
upon completion of a first session of an application that interacts with an orchestration agent for a generative machine learning model:
generating a long-term memory data object according to a long-term memory type specified for the application based, at least in part, on one or more turn inputs of the first session provided to the generative machine learning model via the orchestration agent;
storing the long-term memory data object to a data store accessible to one or more orchestration agents, including the orchestration agent, that interact with the generative machine learning model for the application;
upon initiation of a second session of the application that interacts with one of the one or more orchestration agents:
identifying the long-term memory data object as associated with the second session of the application;
obtaining the long-term memory data object from the data store; and
based, at least in part, on the long-term memory data object, providing as part of one or more inputs to the generative machine learning model received via the second session of the application.

15. The one or more non-transitory, computer-readable storage media of claim 14, wherein, in generating the long-term memory data object according to the long-term memory type, the program instructions cause the one or more computing devices to implement causing a different generative machine learning model or the generative machine learning model to create a summary based, at least in part, on the one or more turn inputs.

16. The one or more non-transitory, computer-readable storage media of claim 14, storing further program instructions that when executed on or across the one or more computing devices, cause the one or more computing devices to further implement causing the long-term memory data object to be modified based, at least in part, on the one or more inputs to the generative machine learning model received via the second session of the application.

17. The one or more non-transitory, computer-readable storage media of claim 14, wherein, in identifying the long-term memory data object as associated with the second session of the application, the program instructions cause the one or more computing devices to implement searching a long-term memory data object index to obtain the long-term memory data object.

18. The one or more non-transitory, computer-readable storage media of claim 14, wherein the long term memory type is specified in a request to create the one or more orchestration agents, causing the one or more orchestration agents to be deployed as part of a service of a provider network.

19. The one or more non-transitory, computer-readable storage media of claim 14, wherein the long term memory type is a semantic memory type.

20. The one or more non-transitory, computer-readable storage media of claim 14, wherein at least part of the long term data object is shared with a plurality of different user-specific long term data objects.
